(19) United States
(12) Patent Application Publication
(10) Pub. No.: US 2012/0059706 A1
(43) Pub. Date: Mar. 8, 2012

(54) Methods and Apparatus for Transforming User Data and Generating User Lists

(76) Inventors: Vishal Goenka, Foster City, CA (US); Vikas Jha, Hillsborough, CA (US); Nicholas Cherry, San Francisco, CA (US); Rajas Moonka, San Ramon, CA (US); David Monsees, San Francisco, CA (US); Anurag Agarwal, Sunnyvale, CA (US)

(21) Appl. No.: 13/223,179

(22) Filed: Aug. 31, 2011

Related U.S. Application Data
(60) Provisional application No. 61/379,106, filed on Sep. 1, 2010.

(51) Int. Cl. G06F 17/30; G06Q 30/02

(52) U.S. Cl. 705/14.41; 707/756; 705/14.67; 705/14.49; 705/14.71; 707/E17.005; 707/E17.044

(57) ABSTRACT

Among other disclosed subject matter, a computer-implemented method for managing data includes receiving user data from a data provider. The user data includes user information in a first format. The method includes transforming the user data in the first format to user data in a second format. The user data in the second format includes a subset of the user information and the second format is defined by a data subscriber. The method includes providing the user data in the second format to the data subscriber.

### CROSS-REFERENCE TO RELATED APPLICATIONS

This application claims the benefit of priority Under 35 U.S.C. §119(e) of U.S. Provisional Application Ser. No. 61/379,106, filed on Sep. 1, 2010. The disclosure of the prior application is considered part of and is incorporated by reference in the disclosure of this application.

### BACKGROUND

This document relates to data management.

As an individual visits and interacts with websites, content publishers (e.g., Yahoo!) and/or advertisers may collect user data related to the individual. For example, the user data collected by a content publisher can include information associated with products, services or articles that the individual expressed interest in by viewing the item, clicking on the item, searching for the item, etc. In addition, the user data can include search terms, search results, data entered into fields such as a registration form and other data from interactions with the website, such as moving a mouse over an advertisement. The user data can be collected using arbitrary name/value pairs and stored in proprietary formats.

The content publishers can use the collected data in their online advertising campaigns. For example, the content publishers can use the user data to personalize advertising and target advertising. In addition, the content publishers can sell/trade the data with other third parties, such as data aggregators (e.g., BlueKai), who buy user data from a large number of content publishers and/or advertisers and resell the aggregated data.

### SUMMARY

This disclosure relates to data management.

In one aspect, a computer-implemented method for managing data includes receiving user data from a data provider. The user data includes user information in a first format. The method includes transforming the user data in the first format to user data in a second format. The user data in the second format includes a subset of the user information and the second format is defined by a data subscriber. The method includes providing the user data in the second format to the data subscriber.

Particular aspects of the subject matter described can be implemented to realize one or more of the following advantages. User data can be collected by a data provider and shared with one or more data purchaser in a format that is specified by each data purchaser.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an example environment in which a data normalization system transforms user data and generates user lists.

FIG. 2 illustrates an example data structure used to store user data.

FIG. 2a illustrates an example of user data collected by the data provider 104.

FIGS. 3 and 4 are flow charts of an example process for using the data normalization system.

FIG. 5 is a block diagram of an example computer system that can be used to implement the data normalization system.

Like reference symbols in the various drawings indicate like elements.

### DETAILED DESCRIPTION

Systems and methods are described for providing a centralized system for transforming and presenting user data. A data normalization system receives user data from a data provider that was collected by the data provider in a format defined by the data provider and transforms the user data to a custom data model defined by the data purchaser. A custom data model can be defined by each data purchaser and the user data can be transformed for each data purchaser. The data normalization system can augment and/or supplement the user data with reference data provided by the data provider or by another source. The data normalization system provides the transformed data to the data purchaser that can use the transformed data in connection with its online advertisements. The data normalization system can also generate user lists using the custom data models.

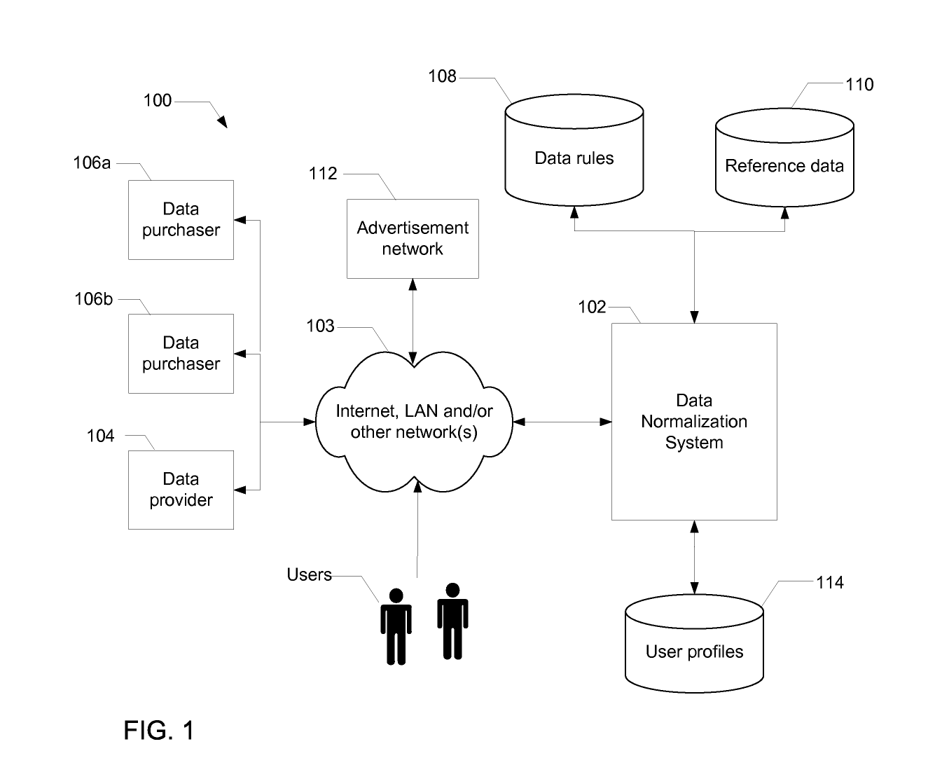

FIG. 1 is a block diagram of an example environment 100 in which a data normalization system 102 transforms user data and generates user lists. In general, the data normalization system 102 receives user data collected by a data provider 104. The data normalization system 102 receives the user data in a proprietary or arbitrary format and applies data rules 108 to normalize the user data and restructure the user data according to a custom data model. In some implementations, the custom data model can be defined by the data purchaser 106. In some implementations, the data rules 108 can be defined by the data provider 104 based on the data purchaser's custom data model. The transformed data is provided to the data purchaser 106 and can be used for a variety of purposes including ad personalization, targeted advertising or to determine the amount to bid on advertisement placement.

Advantageously, the described system may provide for one or more benefits, such as providing custom data models that include only user data that is specified by the data purchaser, which allows the granularity of information to be high. Because the custom data models provide high levels of relevant details, the data purchaser 106 can effectively use the custom data models in its online advertising campaign.

The example environment 100 includes a network 103 such as a local area network (LAN), wide area network (WAN), the Internet, or a combination thereof. The network 103 connects users, the data provider 104, the data purchasers 106a and 106b, the data normalization system 102 and an advertisement network 112.

The data provider 104 is an entity, such as a content publisher or data aggregator, that collects user data (i.e., information associated with the user's activities on a website and/or user's interactions with advertising or other user data). For example, a data provider 104 can operate websites and/or advertising hosted on a website and collect user data from users that visit the websites or interact with the advertising. As a user browses or searches for different products on the website, the data provider 104 can collect user data related to the products the user purchases or expressed some interest in, such as information related to the price of products and services, product names, general categories of products and/or manufacturer or brand information. In addition, the data provider 104 can collect other information, such as information related to the user's geographical location, time and date information, IP address, contextual keywords and/or webpage contextual information and personal or demographic information that the user provided in registration forms (e.g., zip code, age, ethnicity, and/or hobbies).

As the data provider 104 collects a particular user's data, the data provider 104 associates the particular user's data to a unique user identification (i.e., a user ID), which can be provided by the data normalization system 102 and/or the data provider 104. The user ID can be associated with a cookie placed on the user's Internet-connected device (e.g., a computer, a tablet computer or a smart phone) and can be used to identify the particular user's data as collected by the data provider 104. In some implementations, a cookie matching service can be used to share user IDs between the data provider 104 and the data normalization system 102.

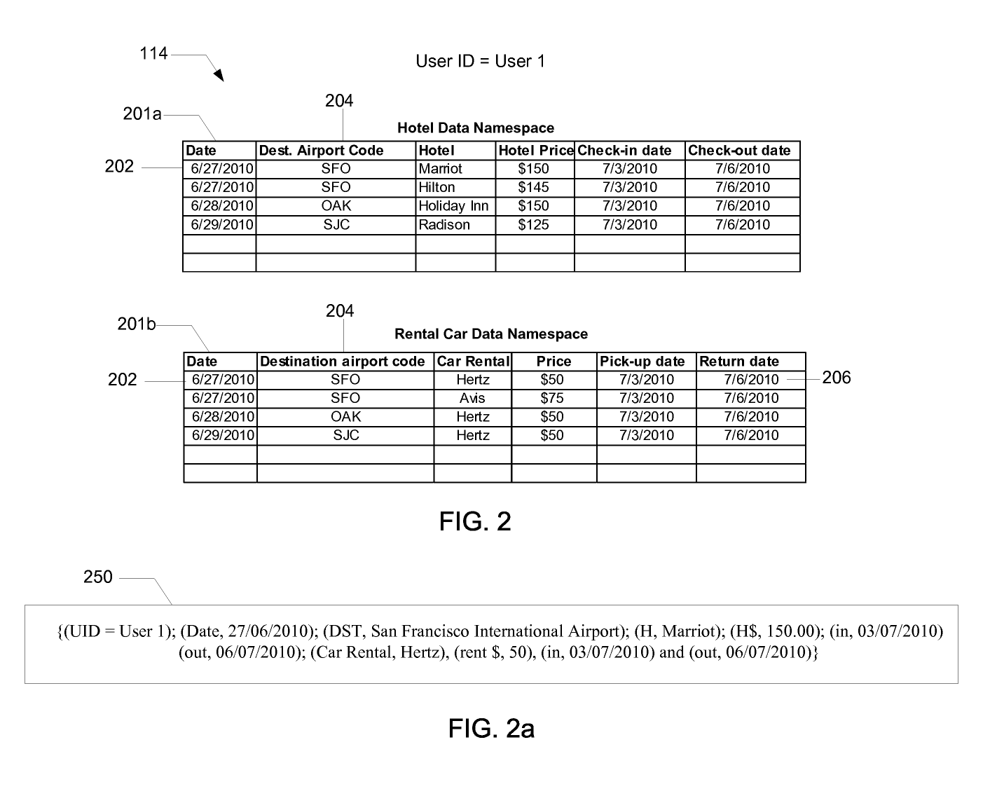

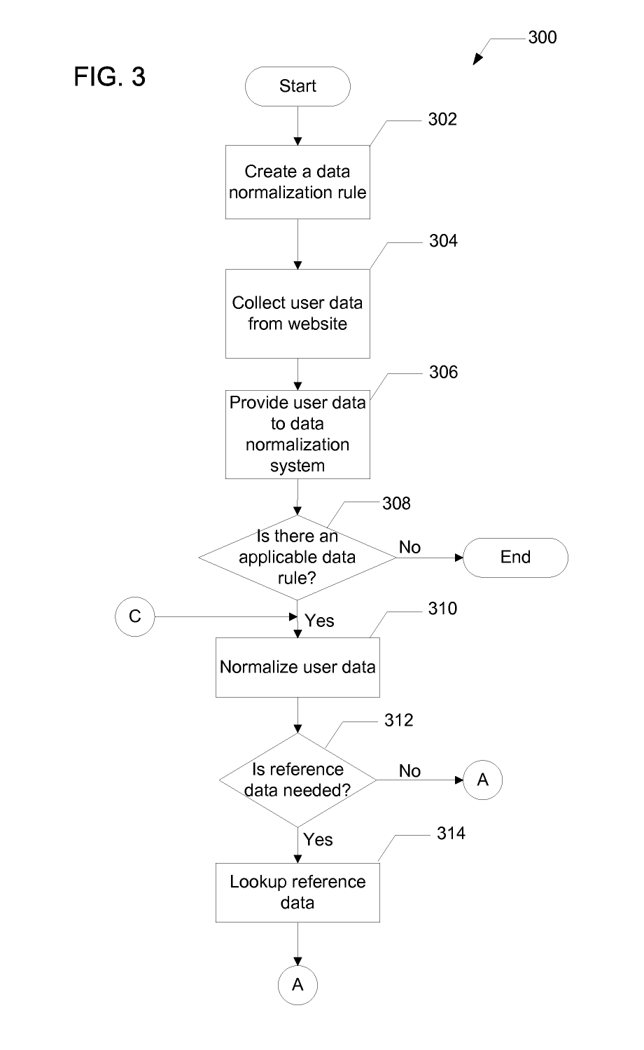

The data providers 104 can collect the user data using various techniques. For example, a data provider 104 can use pixels or tags to collect user data. In some implementations, the pixels or tags contain name/value pairs that represent data attributes. For example, a data attribute, such as the price of a camera, can be represented by a name/value pair such as (U1, $599) or the name of a product can be represented by a name/value pair such as (Name, D50). The data provider 104 can use proprietary name/value pairs or arbitrary names. For example, a first data provider 104 can use the name “U1” to represent the price information collected on its website and a second data provider 104 can use the name “Price” to represent the price information collected on its website. In addition to scalar values (e.g., integers, floating point numbers and character strings), the name/value pair can include complex structures such as a comma separated list or a name/value pair (i.e., a nested name/value pair). As a user visits a website or interacts with advertisements, the pixels or tags collect the user data and transmit the user data to the data normalization system 102. FIG. 2a illustrates example user data 250 collected by the data provider 104.

Although only one data provider 104 is shown in FIG. 1, multiple data providers 104 can interact with the data normalization system 102.

The data purchasers 106a and 106b purchase/subscribe to the user data collected by the data provider 104. For example, the data purchasers 106a and 106b can purchase the user data, rent the user data, exclusively license user data for a predetermined period of time. The data purchasers 106a and 10b can define custom data models for the user data. For example, the data purchasers 106a and 106b can require that the user data it purchases/subscribes to from data provider 104 includes specific names used to describe the data, particular items of the user data it is interested in and can specify how the user data is structured or formatted (i.e., by defining a custom data model). In some implementations, each data purchaser 106 can define its own data model. For example, data purchaser 106a can require that the user data it purchases/subscribes to include the product name, price information and the date the user data was collected and data purchaser 106b can require that the user data it purchases include the product name, brand information, price information and whether the product is new or refurbished. The data purchasers 106a and 106b provide these requirements to the data provider 104.

Using the data purchaser's requirements, data rules 108 can be created based on the data purchaser's specifications. The data rules 108 can normalize the user data by, for example, converting an arbitrary name/value pair to have values that are specified by the data purchaser. For example, if a data provider 104 represents a destination city as (DST, San Fran), the data purchaser 106 can require that DST be normalized to “Destination” and “San Fran” be normalized to “San Francisco” In some implementations, the data rules 108 can format the data such that the data provided to the data purchaser is in accordance with the data purchaser's requirements. For example, data rules 108 can format date information to be presented as mm/dd/yyyy or dd/mm/yyyy. In some implementations, the data rules 108 can be used to infer data from the user data collected by the data provider 104. For example, a data rule 108 can be created to infer that a user is interested in Secure Digital cards based on user data related to a user's interest in digital cameras. Data rules 108 can also be used to manipulate or edit the user profiles 114 stored on the data normalization system 104.

In some implementations, the data normalization system 102 can provide a custom application programming interface (“API”) to create the data rules 108. In some implementations, the data provider 104 uses a scripting language to create the data rules 108. The data normalization system 102 stores the data rules 108 in a database or some other type of memory.

The data normalization system 102 can be implemented as several components of hardware, each of which is configured to perform one or more functions, may be implemented in software where one or more software and/or firmware programs are used to perform the different functions, or may be a combination of hardware and software. In addition, the data normalization system 102 can be an independent system or part of a larger system, such as a data exchange system that serves as an intermediary between the data provider 104 and the data purchasers 106 and facilitates the purchase, sale and/or licensing of user data, user lists or other information.

The data normalization system 102 is connected to the network 103 and receives user data (e.g., that has been collected by the data provider 104) and data rules 108 (e.g., that have been created by the data provider 104 or data purchaser 106). The data normalization system 102 stores the user data and the data rules 108 in memory or a database. The data normalization system 102 can also access reference data 110, which is described in greater detail below.

The data normalization system 102 is configured to apply the data rules 108 to convert the user data from the data provider's name/value format to the data purchaser's custom data model. The data normalization system 102 can apply the data rules 108 as the user data is received (i.e., real-time data transformation), or it can apply the data rules 108 at a predetermined time or when the data normalization system 102 is offline (i.e., batch mode data transformation).

In addition to normalizing and/or transforming the user data, the data rules 108 can be used to cause the data normalization system 102 to access reference data 110 to supplement the user data. The reference data 110 can be any type of additional data to supplement the user data. In some implementations, the reference data 110 is provided by a source other than the data provider 104. In some implementations, the reference data 110 can be accessed by the data provider 104 and/or the data normalization system 102. Example reference data includes additional product information, product rating information, movie listings, stock prices, and/or local school information. The reference data 110 can also be provided by the data provider 104 or can be data that has been collected by another data provider that the data provider 104 has permission to access. In some implementations, the reference data 110 includes publicly accessible data, such as weather information and/or geographical data. The data normalization system 102 can access the reference data using, for example, API's provided by the reference data source or can be stored in a database or memory connected to the data normalization system 102.

The data normalization system 102 can use the reference data to supplement the user data collected by the data provider 104. For example, if the user data includes a name/value pair indicating the user is searching for hotels in Hawaii but the user's geographical location information indicates that the user is in San Francisco, the data normalization system 102 can infer that the user plans to travel to Hawaii and can supplement the user data to include the airport codes that are near the user (e.g., SFO or OAK) and airport codes near the hotels (e.g., HNL). As another example, if the user data indicates that the user viewed a Nikon D40 camera, the data normalization system 102 can access the reference data 110 and augment the user data to include additional details about the Nikon D40, such as the price range (e.g., $300-$500) and the product category (e.g., DSLR camera).

In some implementations, the data normalization system 102 stores the transformed user data in a user profile 114 that is associated with the user ID and the data provider 104 and/or the data normalization system 102. Each profile can be stored in a datastructure (spreadsheet or table) and can be accessed by the user ID.

FIG. 2 illustrates an example user profile 114 that corresponds to User 1's user ID. The example user profile 114 includes namespaces 201a and 201b, where each namespace 201 represents a user's data that has been transformed according to a particular data purchaser's 106 specification. Each namespace 201a and 201b includes a title, which can be used by the data normalization system 102 and/or the data rules 108 to specify actions related to a particular namespace. For example, namespace 201a is titled “Hotel Data Namespace” and can correspond to user data that has been transformed according to data purchaser 106a's custom data model and contains information related to hotels the user was interested in. Namespace 201b is titled “Rental Car Data Namespace” and can correspond to user data that has been transformed according to data purchaser 106b's custom data model and contains information related to rental cars. Although the example user profile 114 includes two namespaces 201a and 201b, the user profile 114 can include as many namespaces 201 as needed based on, for example, the data rules 108 defining a particular purchaser's needs.

Each namespace 201 includes rows and columns. The columns represent data attributes 204 that were collected by the data provider 104, normalized user data, reference data and/or other data. For example, namespace 201a includes the following data attributes: destination airport code, hotel name, hotel price, and the check-in/check-out dates. Each row represents a user record 202 and each cell 206 represents the data attribute that was captured by the data provider 104 or supplied by reference data.

In some implementations, the data attributes in each cell 206 are not limited to scalar values and can be complex structures such as lists, maps, or pre-defined tuples. These complex structures can be generated using the data rules 108. For example, a tuple similar to (check-in date, check-out date) can be created to represent the hotel check-in date and check-out date. As another example, a tuple similar to (Sat, Sun, Mon. Tues.) can be created to represent the hotel check-in date and check-out date.

In some implementations, the data normalization system 102 can generate user lists by applying list generation rules (i.e., rule based analysis) to provider or user provided data. The list generation rules can be provided by the data provider 104 and/or the data purchasers 106. In some implementations, user lists are a collection of user IDs or namespaces 201 that are characterized by a list definition. A user list can be a list of users that share a common interest in a product or service. For example, a user list can be generated where the members of the list have recently viewed advertisements for particular type of car or have recently searched for airline tickets to London. The data normalization system 102 can generate the user lists using other known list generation techniques such as machining learning analysis. The resulting user lists can be provided to the data providers 104 and data purchasers 106. The user list can include the users' user IDs, other identifying information, and/or the users' relevant namespaces (e.g., the namespace containing user data relevant to the common interest).

In some implementations, the advertisement network 112 is an online advertising system. Data purchasers 106 can implement online advertising campaigns using the advertisement network 112 and can instruct the advertising network 112 to show certain content (e.g., advertisements) to particular users and specify the amount the data purchaser 106 is willing to pay for the placement.

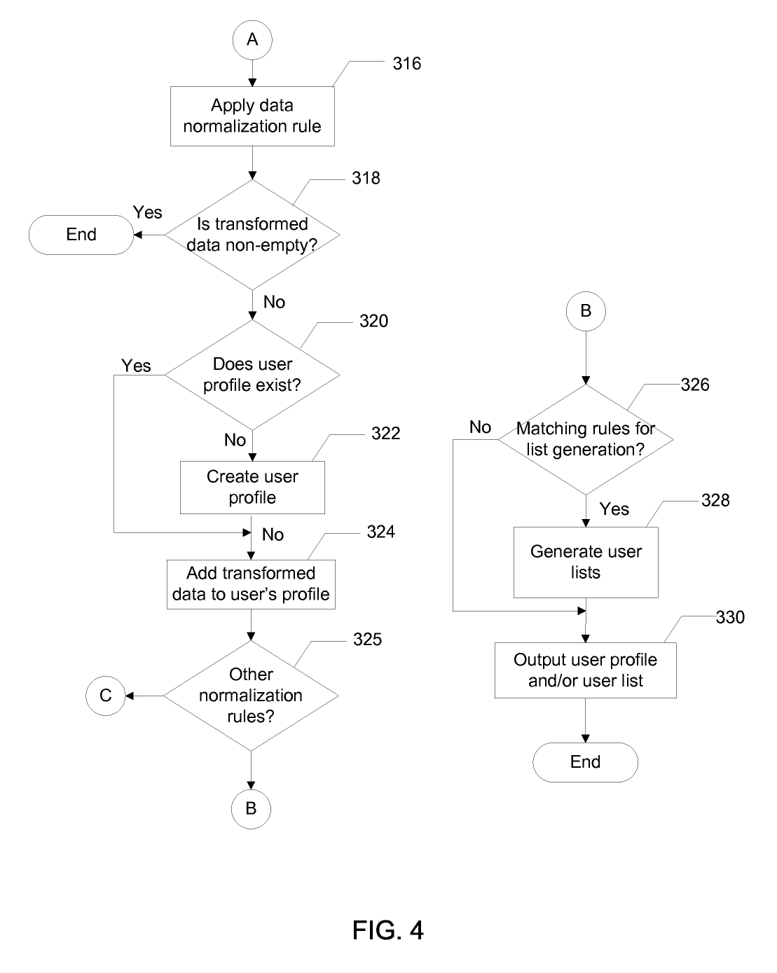

FIGS. 3-4 are flowcharts of an example process for transforming data. While reference is made to cookies, other means of tracking user identification and user data can be used. For the purposes of this example method, a cookie associated with the user ID is assumed to have been placed on the user's computer. If the cookie has not been placed on the user's computer, then either the data provider 104 or the data normalization system 102 can provide the user identifying information or user data as required.

The example process 300 begins with the generating of data rules 108 (stage 302). For example, data provider 104 can create data rules 108 based on a data purchaser's requirements (stage 302). In some implementations, the data purchaser 106 can specify the particular data attributes it is interested in, the order of the data and the naming convention. In some implementations, the data purchaser 106 can specify the number or type of user records it is interested in. For example, the data purchaser 108 may only be interested in the most recently collected user data. In some implementations, the data provider 104 uses the data normalization system 102 to create the data rules 108 in accordance with the data purchaser's requirements. The data normalization system 102 can store the data rules in a database or other memory. In some implementations, the data provider 104 can create data rules 108 and transmit the data rules to the data normalization system 102.

At stage 304, user data is collected. For example, the data provider 104 can collect user data as a user interacts with a website or advertisement. The data provider 104 can collect user data associated with articles read by the user, products or services viewed by the user or otherwise expressed interest in, products searched for by the user and/or services that the user purchased. In some implementations, the data provider 104 can use tags or pixels to capture name/value pairs that represent the user data. The user data can be associated with the user ID stored on the user's Internet-connected device.

At stage 306, the user data is provided/identified (e.g., to the data normalization system 102). In some implementations, the data normalization system 102 stores identified/received user data in memory.

At stage 308, identified/received user data is analyzed to determine if the data is required to be normalized. For example, the data normalization system 102 can determine if there are associated data rules 108 that should be applied to normalize the data. The data normalization system 102 can determine if data rules 108 should be applied by, for example, searching for data rules 108 that were created by the data provider 104 and that relate to the collected user data. For example, if the user data is related to deep sea fishing equipment and the data provider 104 did not create data rules 108 to normalize deep sea fishing equipment data, no normalization will be applied. If the data normalization system 102 determines that there are no applicable data rules 108, then the process 300 terminates.

At stage 310, the user data is normalized. For example, the user data can be normalized such that the data attribute is given names specified by the data purchaser 106, such as “Price” or “Brand.” In addition, the user data can be normalized so the value conforms to a format specified by the data purchaser 106. For example, the data rules 108 can normalize two scalar data values to a tuple or can abbreviate city names.

At stage 312 (e.g., after the user data is normalized), a check is made to determine if any reference data is needed to augment the user data. For example, the data normalization system 102 can determine whether reference data 108 is needed to augment the normalized user data. In some implementations, the data normalization system 102 inspects the data rules 108 to determine whether any reference data is needed to augment the normalized data. If reference data 108 is needed, it is accessed at stage 314. For example, the data normalization system 102 can access a database that stores the reference data, download the reference data from the data provider's servers using the data provider's API, or access another data provider's reference data. In addition, the data normalization system 102 can access any reference data source that is publicly or privately accessible.

At stage 316, the reference data is incorporated into the normalized data (in accordance with the data rules). For example, the data normalization system 102 can apply the data rules 108 to restructure the normalized user data such that the user data is formatted according to the data purchaser 106's specifications and incorporate the reference data. The data rules 108 can filter the user data so the transformed data includes only the specific data attributes that the data purchaser requested and/or puts the data in a specific order. For example, if the normalized data includes a destination airport code, hotel information, airfare information and car rental information, the transformed data can include only the destination airport code and the car rental information.

At stage 318, a determination is made whether the transformed data is non-empty. For example, the data normalization system 102 can determine whether the transformed data is non-empty or equal to the null-set. If the transformed data is empty, then process 300 terminates.

At stage 320, if the transformed data is not empty, a user profile associated with a user request is determined. For example, the data normalization system 102 determines if a user profile 114 corresponding to the user ID associated with the user data exists. If the user profile does not exist, one can be created (e.g., the data normalization system 102 creates the user profile 114) (stage 322).

At stage 324, after the user profile 114 is created/located, the profile can be updated with any transformed data. For example, the data normalization system 102 will update the appropriate namespace(s) 201 of the user profile 114 to include the transformed data. For example, referring to the example user profile 114 of FIG. 2, if the data normalization system 102 applied the data rules 108 associated with data purchaser 106a, the data normalization system 102 would update namespace 201a to include the transformed data.

In some implementations, the data normalization system 102 can delete user records 202 from the user profile 114 based on data rules 118. The data provider 104 can create data rules that delete older user records 202 in a namespace of the user profile 114 or from all the namespaces of the user profile 114. For example, the data rules 108 can delete all user records 202 older than thirty days or can delete all but the most recent user record 202.

After a given user profile 114 is updated, a determination is made if other data rules should be applied to the user data (stage 325). For example, the data normalization system 102 can determine whether there are other data rules 108 that could be applied to the user data to transform the user data according to a second data purchaser's requirements. If other data rules 108 exist, the process 300 returns to stage 310 to normalize and transform the user data based on data rules 108.

After all applicable data rules have been run and the user profiles have been updated, a determination is made as to whether any list generation rules related to the data attributes contained in the updated user profile exist (326). For example, the data normalization system 102 can analyze the updated user profile 114 and the data attributes contained in the user profile 114 and determine if any list generation rules to generate a user list related to the data attribute exists. For example, if the user profile 114 contains data attributes that suggest the user is interested in purchasing a digital camera, the data normalization system 102 will search for a list generation rule to generate a user list of users interested in purchasing a digital camera and that are associated with data provider 104. If no applicable rule exists, then the updated user profile (e.g., user profile 114) is output to the data purchaser or is otherwise made accessible to the data purchaser (stage 330). If an applicable list generation rule exists, the rules are applied to generate the user list(s) (stage 328). For example, the data normalization system 102 can apply the list generation rules to generate the user list, which includes the recently updated user profile 114.

In some implementations, the data normalization system 102 does not use list generation rules to generate user lists and instead generates user lists using machine learning based analysis. For example, the data normalization system 102 can analyze the recently updated user profile 114 and the other user profiles 114 associated with the data provider 104 to determine whether the recently updated user profile 114 is similar to other stored user profiles 114. If the recently updated user profile 114 is similar to other user profiles 114, then the data normalization system 102 will generate a user list. For example, if the data normalization system 102 determines that the user profile 114 contains data attributes related to traveling to San Francisco, the data normalization system 102 can apply machine learning based techniques to analyze the other user profiles 114 associated with the data provider 114 to generate a list of users interested in traveling to San Francisco. In some implementations, the data normalization system 102 can use machine learning based analysis in combination with advertisement performance metrics, such as click through rates, conversion rates (i.e., number of sales resulting from a user clicking on the advertisement), offline metrics, such as brand awareness to generate user lists, or other information to generate user lists.

After the data purchaser 106a receives the transformed data and/or user lists, the data purchaser 106a can interact with the advertisement network 112 and improve the performance of its advertisements and subsequently, its return on investment. For example, the data purchaser 106a can improve its targeted advertisements by analyzing the user profiles in the user list and determining how much it is willing to bid for its advertisements to be shown to each user in the user list. In addition, the data purchaser 106a can use the transformed data and/or user lists to improve its ad personalization. For example, the data purchaser 106 can instruct the advertisement network 112 to display specific advertisements related to the specific data attributes contained in the user profile 114 to the user. The data purchaser 106a can also use the transformed data and/or user lists to determine the value of the data and/or how well the advertising campaign using the user list and/or transformed data is performing. For example, the data purchaser 106a can receive advertisement performance metric information such as click through rates and conversion rates for each advertising campaign, and the data purchaser 106a can correlate this information to the user lists and/or transformed data used in the advertising campaign to determine the value of the data and/or the return on its investment in the user data and/or user lists.

As described above, process 300 can operate in real time as the user data is collected by the data provider 104. In some implementations, the process 300 can operate in batch mode and transform a set of user data stored in memory accessible by the data normalization system 102 or a set of user data that is transmitted by the data provider 104 to the data normalization system. The data normalization system 102 can transform the set of user data at predetermined times or when the data normalization system 102 is not running at or near full capacity. In addition, the user lists can be generated at predetermined times.

In some implementations, the process for transforming user data begins by receiving user data. For example, the user data can be collected by a data provider 104 in a format defined by the data provider 104 and transmitted to the data normalization system 102. The user data is then transformed from the first format to a second format. For example, the data normalization system 102 can transform the user data from the data provider's format to a custom format defined by the data purchaser/subscriber 106. The custom format can include a subset of the user data collected by the data provider 104. The transformed user data is then provided to the data purchaser/subscriber 106.

### USE EXAMPLE

An example use case is described below. The example use case is merely for illustrative purposes and is not meant to limit the scope of the claims or disclosure.

Acme Travel, a data provider, operates an online travel website. The website allows a user to make travel arrangements such as searching for airline tickets, purchasing airline tickets, searching for hotels, reserving a hotel room, searching for rental cars, reserving a rental car, searching for cruise packages and reserving cruise packages. As the user interacts with the website, user data associated with a user's searches and the items the user views or is interested in is collected by Acme Travel.

Beta-Car, a data purchaser, is a car rental company that operates in northern California. Hoping to increase its return on its investment in online advertising, Beta-Car is interested in purchasing user data and/or user lists associated with people interested in traveling to the San Francisco Bay area. For example, Beta-Car may intend to use the user data for ad personalization, such as displaying Beta-Car advertisements to website users known to be traveling to San Francisco.

Beta-Car can purchase/lease user data from Acme Travel. Beta-Car, however, can specify the particular types of user data it is interested in and how the data should be named. For example, Beta-Car can specify that it is interested in a user's destination airport represented as the airport code, car rental companies that the user has viewed, the daily rate, the check-in date, check-out date and the date the user data was collected, where the date is represented using the format mm/dd/yyyy (i.e., month/date/year). Based on Beta-Car's requirements, Acme Travel can create data rules 108 to transform the user data such that the transformed data is formatted to Beta-Car's requirements. In addition, Acme Travel can create data rules 108 that generates inferences based on the user data. For example, if the collected user data includes information related to hotel reservations and airline tickets but does not include information related to rental car reservations, Acme Travel can create data rules 108 that infer a user's need for a rental car. For ease of discussion, these data rules 108 will be referred to as BC data rules. Acme Travel provides the BC data rules to the data normalization system 102.

User 1, located in New York City, is interested in traveling to San Francisco and uses a travel website, operated by Acme Travel, to plan his travel arrangements. As User 1 plans his trip to San Francisco, Acme Travel collects data associated with the searches and the specific items that User 1 selects or reviews. Acme Travel collects the data using arbitrary names and value formats. Example user data 250 that is collected by Acme Travel is shown in FIG. 2a. As the user data is collected, the user data and User 1's user ID is transmitted to the data normalization system 102.

When the data normalization system 102 receives User 1's user data and his unique ID, the data normalization system 102 stores the user data and the unique ID. The data normalization system 102 then determines if any data rules 108 are applicable to the user data. Because the user data 250 includes rental car information, the data normalization system 102 applies the BC rules to normalize the user data and formats the data according to the BC data rules. The data normalization system 102 then updates User 1's user profile 114 and provides User 1's user profile 114 to Beta-Car. The first user record 202 of namespace 201b of FIG. 2 illustrates an example of user 1's transformed data.

In some situations, the user data does not include rental car information but includes information related to hotel reservations and airline ticket information. Because the user data includes hotel information and airline ticket information, the data normalization system 102 can apply the BC rules to normalize the user data and format the data according to the BC data rules. The pick-up data and return date can be inferred from the user data related to the hotel information and the airline ticket information. User 1's user profile 114 is then updated.

The data normalization system 102 runs a list generation rule, specified or provided by Acme Travel, on the set of user profiles 114 associated with Acme Travel to generate a user list. For example, the data normalization system 102 can apply a data rule 108 that analyzes user profiles 114 associated with Acme Travel to determine whether any users are interested in traveling to the San Francisco Bay area and generate a user list that includes these users, which would include User 1's user profile.

The user list is also provided to Beta-Car, which can transmit the user list to the advertisement network 112. Beta-Car can instruct the advertisement network to show Beta-Car rental ads to User 1 or other members of the user list. In addition, Beta-Car can use the user list to help determine the amount it bids for advertisement placement. For example, because Beta-Car is interested in increasing the effectiveness of its online advertising, Beta-Car can increase its advertisement bid for users that are a member of the user list and increase the likelihood that its ads will be shown to User 1 and/or other users in the user list. In addition, Beta-Car can provide User 1's user profile to the advertisement network 112 so the Beta-Car advertisements that are shown to User 1 are based on User 1's user profile. For example, Beta-Car can advertise rental cars in the price range that User 1 has previously searched.

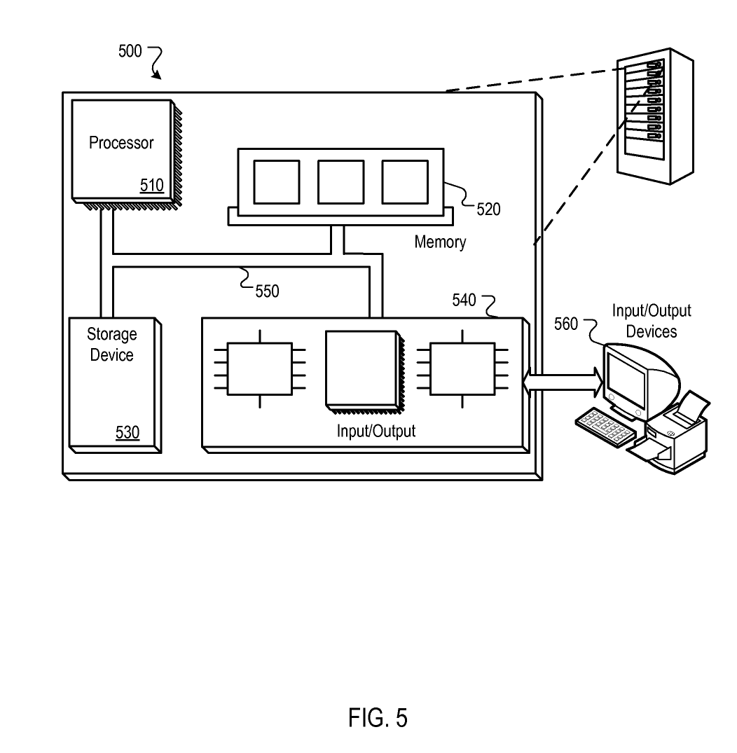

FIG. 5 is block diagram of an example computer system 500 that can be used to implement the data normalization system 102. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, or some other large capacity storage device.

The input/output device 540 provides input/output operations for the system 500. In one implementation, the input/output device 540 can include one or more of a network interface device, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

The various functions of the data normalization system 102 can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The data normalization system 102 can be distributively implemented over a network, such as a server farm, or can be implemented in a single computer device.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, a processing system. The computer readable medium can be a machine readable storage device, a machine readable storage substrate, a memory device, or a combination of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on a computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of embodiments of the invention have been described. In some cases, the actions recited in the claims can be performed in a different order and still achieve desirable results. In addition, the processes depicted in the accompanying figures do not necessarily require the particular order shown, or sequential order, to achieve desirable results. Nevertheless, it will be understood that various modifications may be made without departing from the spirit and scope of the invention. For example, the data normalization system 102 can be configured to analyze the user profiles 114 or transformed user data to determine the accuracy of the data. In some implementations, the data normalization system 102 can determine the accuracy of the user data by comparing the user data to a validation data set. The validation data set can be any set of user data that the data purchaser 106 believes to be accurate or believes to be of high quality and can be provided by a third-party data provider or can be provided by the data purchaser 106a. For example, the data normalization system 102 can validate the user's geographical location data by comparing the user data to a validation data set provided by a magazine publisher that includes zip code information. In some implementations, the validation data set can be transformed according to the same data rules 108 used to normalize and restructure the user data. The data validation can be performed while the data normalization system is offline or at scheduled times.

In some implementations, if the data normalization system 102 determines that a user data is inaccurate, the data normalization system 102 can correct the any inaccuracies in the user data based on the validation data set. In some implementations, the data normalization system 102 can notify the data provider 104 and/or the data purchaser 106 that there are inaccuracies in the user data. Accordingly, other embodiments are within the scope of the following claims.

What is claimed is:

1. A computer-implemented method, the method comprising:
receiving user data from a data provider, wherein the user data comprises user information in a first format;
transforming the user data in the first format to user data in a second format, wherein the user data in the second format comprises a subset of the user information and the second format is defined by a data subscriber; and
providing the user data in the second format to the data subscriber.

2. The method of claim 1 wherein the first format is defined by the data provider.

3. The method of claim 1 wherein the user information in the first format comprises information collected from a web site.

4. The method of claim 1 wherein user information in the first format comprises a name/value pair defined by the data provider.

5. The method of claim 4 wherein the name/value pair represents a second name/value pair.

6. The method of claim 1 wherein the data in the second format comprises a user record and a data attribute.

7. The method of claim 6 wherein the data attribute comprises at least one of scalar data, a list or a tuple.

8. The method of claim 1 wherein transforming the user data comprises:
applying a rule to normalize the user data in the first format and to map a subset of the normalized user data in the first format to the second format.

9. The method of claim 8 wherein the rule is specified by the data provider based on a requirement defined by the data subscriber.

10. The method of claim 8 wherein the second format comprises a user record and a data attribute.

11. The method of claim 1 wherein the second format comprises a namespace, wherein the namespace comprises a title, a column, a row and a cell.

12. The method of claim 11 wherein the cell represents a value of a data attribute.

13. The method of claim 1 wherein transforming the data comprises:
applying a rule to normalize the user data in the first format;
accessing reference data, wherein the reference data comprises product-related data and/or services-related data;
supplementing the normalized user data with the reference data; and
applying the rule to map the user data in the first format and the reference data to the second format.

14. The method of claim 13 wherein the reference data further comprises at least one of weather data, location data, airport data, movie listings, stock prices, school information or data collected by a second data provider.

15. The method of claim 13 wherein accessing reference data comprises at least one of accessing stored reference data provided by the data provider or using an application programming interface to access the reference data.

16. The method of claim 1 wherein the data in the second format is used for advertisement personalization.

17. The method of claim 1 wherein the data in the second format is used for advertisement targeting.

18. The method of claim 1 wherein the data in the second format is used to determine an advertisement bid.

19. The method of claim 1 wherein the data in the second format is used to determine advertisement performance.

20. The method of claim 1 further comprising generating a user list based on analysis of the data in the second format.

21. The method of claim 20 wherein the analysis comprises machine learning analysis.

22. The method of claim 21 wherein the machine learning analysis comprises analyzing at least one of advertisement performance metric information or offline metric information.

23. The method of claim 21 wherein the analysis comprises rule based analysis.

24. The method of claim 20 wherein the user list is used for advertisement targeting.

25. The method of claim 20 wherein the user list is used for advertisement personalization.

26. The method of claim 20 wherein the user list is used for advertisement bidding.

27. The method of claim 20 wherein the user list is used to determine advertisement performance.

28. The method of claim 1 further comprising:
validating the user data in the second format, wherein validating the user data in the second format comprises comparing the user data in the second format to a validation data set and correcting errors in the user data in the second format.

29. The method of claim 28 wherein the validation data set comprises an accurate data set provided by a third party.

30. A system, comprising:
memory storing a data transformation rule and reference data; and
a data normalization system coupled to the memory and configured to receive user data in a first format from a data provider, apply the data transformation rule to normalize the user data in the first format and map the normalized data to user data in a second format, wherein the second format is defined by a data subscriber and provide the user data in the second format to the data subscriber.

31. The system of claim 30, wherein the data normalization system is further configured to access the memory and supplement the normalized user data with the reference data.

32. The system of claim 30, wherein the data normalization system is further configured to generate a user list based on analysis of the data in the second format.

33. A computer readable medium encoded with a computer program comprising instructions that, when executed, operate to cause a computer to perform operations:
receive user data from a data provider, wherein the data comprises user information in a first format;
transform the user data in the first format to user data in a second format, wherein the user data in the second format comprises a subset of the user information and the second format is defined by a data subscriber; and
provide the user data in the second format to the data subscriber.

34. The computer readable medium of claim 33, further comprising instructions that when executed cause the computer to perform operations:
apply a rule to normalize the user information in the first format;
access reference data, wherein the reference data comprises product-related data and services-related data;
supplement the normalized user information with the reference data; and
apply the rule to map the user information in the first format and the reference data to the second format.
